(19) United States
(12) Patent Application Publication
(10) Pub. No.: US 2024/0342889 A1
(43) Pub. Date: Oct. 17, 2024

(54) ELECTRIC HAMMER

(71) Applicant: MAKITA CORPORATION, Anjo-shi (JP)

(72) Inventor: Masanori FURUSAWA, Anjo-shi (JP)

(73) Assignee: MAKITA CORPORATION, Anjo-shi (JP)

(21) Appl. No.: 18/428,562

(22) Filed: Jan. 31, 2024

(30) Foreign Application Priority Data
Apr. 14, 2023 (JP) 2023-066607

(51) Int. Cl. B25D 17/20; A47L 7/00; A47L 9/12; A47L 9/24; A47L 9/28; B23Q 11/00

(52) U.S. Cl. CPC B25D 17/20; A47L 7/0095; A47L 9/12; A47L 9/242; A47L 9/2805; A47L 9/2842; A47L 9/2889; B23Q 11/0046; B25D 2217/0061; B25D 2222/72; B25D 2250/095

(57) ABSTRACT

An electric hammer can collect dust without using an external dust collection device. An electric hammer includes a motor, a body incorporating the motor, a striker assembly operable in response to the motor being driven to strike a bit attached along a striking axis, a dust collection fan rotatable in response to the motor being driven, a dust collection channel having a suction port being open toward a tip of the bit to generate a suction force in the suction port in response to rotation of the dust collection fan, and a dust collector located on the dust collection channel to collect dust sucked through the suction port.

### CROSS-REFERENCE TO RELATED APPLICATIONS

This application claims the benefit of priority to Japanese Patent Application No. 2023-066607, filed on Apr. 14, 2023, the entire contents of which are hereby incorporated by reference.

### BACKGROUND

### 1. Technical Field

The present disclosure relates to an electric hammer.

### 2. Description of the Background

An electric hammer uses a dust collection attachment described in Japanese Patent No. 6379004 for collecting dust generated during, for example, a crushing operation using a bit. The dust collection attachment, through which the bit extends, is open downward. A hose connected to an external dust collection device is held by a hose holder attached to a housing of the electric hammer to connect the lower end of the hose to the dust collection attachment. When the dust collection device starts operating, the dust collection attachment receives a suction force in its opening, sucks generated dust, and collects the dust into the dust collection device through the hose.

### BRIEF SUMMARY

A known electric hammer uses a dust collection attachment with a separate dust collection device to be connected, involving time and effort.

One or more aspects of the present disclosure are directed to an electric hammer that can collect dust without using an external dust collection device.

A first aspect of the present disclosure provides an electric hammer, including:
a motor;
a body incorporating the motor;
a striker assembly operable in response to the motor being driven, the striker assembly being configured to strike a bit attached along a striking axis;
a dust collection fan rotatable in response to the motor being driven;
a dust collection channel having a suction port being open toward a tip of the bit, the dust collection channel being configured to generate a suction force in the suction port in response to rotation of the dust collection fan; and
a dust collector located on the dust collection channel, the dust collector being configured to collect dust sucked through the suction port.

The electric hammer according to the above aspect of the present disclosure can collect dust without using an external dust collection device.

### BRIEF DESCRIPTION OF DRAWINGS

FIG. 1 is a longitudinal central sectional view of an electric hammer.

FIG. 2 is an enlarged view of a body from which a dust box is detached.

FIG. 3 is an enlarged view of the body with a connection port closed with a cap.

### DETAILED DESCRIPTION

Embodiments of the present disclosure will now be described with reference to the drawings.

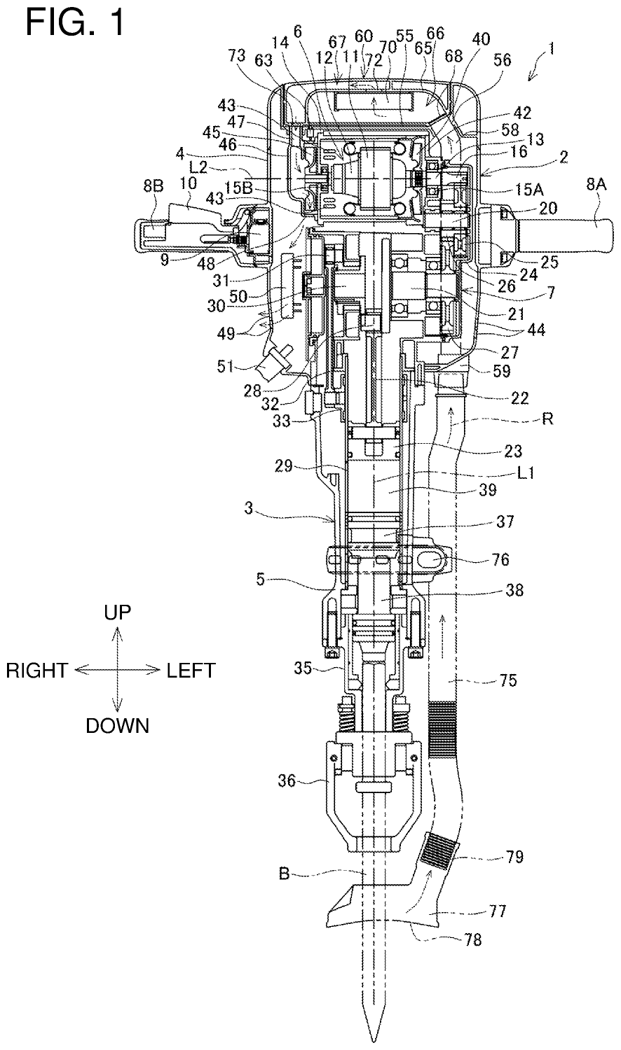

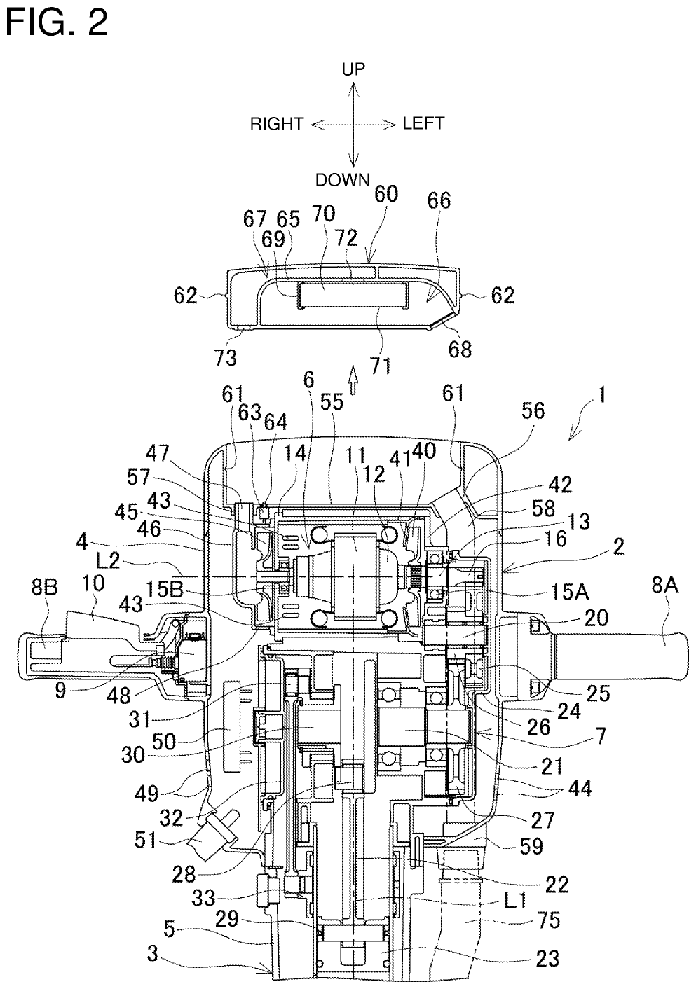

FIG. 1 is a longitudinal central sectional view of an example electric hammer. FIG. 2 is an enlarged view of a body from which a dust box is detached.

An electric hammer 1 includes a body 2 and a striker assembly 3. The body 2 is located in an upper portion of the electric hammer 1. The striker assembly 3 is located in a lower portion of the electric hammer 1. The body 2 includes a box-shaped upper housing 4. The striker assembly 3 includes a lower housing 5. The lower housing 5 is connected to the upper housing 4. The upper housing 4 accommodates a motor 6 and a motion converter 7. The lower housing 5 is cylindrical and holds the striker assembly 3. The striker assembly 3 has a striking axis L1 extending vertically.

A pair of handles 8A and 8B are located on the right and left side surfaces of the upper housing 4. The handles 8A and 8B each protrude laterally outward. The right handle 8B incorporates a switch 9. A switch lever 10 facing upward is located on an upper portion of the handle 8B. The switch lever 10 is pressed to turn on the switch 9.

The motor 6 is located in an upper portion of the upper housing 4. The motor 6 includes a stator 11 and a rotor 12. The rotor 12 includes a rotational shaft 13 with an axis L2 extending in the lateral direction orthogonal to the striking axis L1. The rotational shaft 13 is supported by right and left bearings 15A and 15B. The right and left bearings 15A and 15B are located in a motor housing 14 partitioned inside the upper housing 4. The rotational shaft 13 protruding from the left bearing 15A has a left end receiving a pinion 16.

The motion converter 7 includes a countershaft 20, a crankshaft 21, a connecting rod 22, and a piston 23. The countershaft 20 is supported parallel to the rotational shaft 13 below and to the left of the motor 6 inside a gear housing 24 connected to a lower portion of the motor housing 14. The countershaft 20 receives a first gear 25. The first gear 25 meshes with the pinion 16 on the rotational shaft 13. The countershaft 20 receives a second gear 26 on the right of the first gear 25.

The crankshaft 21 is supported parallel to the countershaft 20 inside the gear housing 24 below the countershaft 20. The crankshaft 21 includes a third gear 27. The third gear 27 meshes with the second gear 26. The crankshaft 21 includes an eccentric pin 28 at a decentered position on its right end face. The connecting rod 22 has its upper end connected to the eccentric pin 28 and its lower end connected to the piston 23. The piston 23 is accommodated in a vertically movable manner inside a cylinder 29 vertically supported in the lower housing 5.

A second crankshaft 30 is supported coaxially with the crankshaft 21 on the right of the crankshaft 21. The second crankshaft 30 engages with the eccentric pin 28 and is thus rotatable as the eccentric pin 28 moves eccentrically. The second crankshaft 30 includes a second eccentric pin 31 at a rotational position opposite to the eccentric pin 28 on the crankshaft 21. A second connecting rod 32 is located on the right of the cylinder 29. The second connecting rod 32 has its upper end connected to the second eccentric pin 31. A counterweight 33 is externally mounted on the cylinder 29 in a vertically movable manner. The second connecting rod 32 has its lower end connected to the counterweight 33.

A cylindrical tool holder 35 is connected coaxially to a lower portion of the lower housing 5. The tool holder 35 can receive a bit B from below. A tool retainer 36 is located below the tool holder 35. The tool retainer 36 engages with the bit B received in the tool holder 35 to prevent the bit B from slipping off.

The striker assembly 3 includes a striker 37 and an impact bolt 38. The striker 37 is accommodated in a lower portion of the cylinder 29. The striker 37 is movable vertically across an air chamber 39 below the piston 23. The impact bolt 38 is accommodated in the tool holder 35 below the striker 37 in a vertically movable manner. At the uppermost position at which the bit B is received, the upper end of the impact bolt 38 protrudes into the cylinder 29.

The cylinder 29, the piston 23, the striker 37, the tool holder 35, and the impact bolt 38 are arranged coaxially on the striking axis L1.

In the upper housing 4, a cooling fan 40 for the motor 6 is located rightward from the bearing 15A on the rotational shaft 13. A baffle 41 is located in the motor housing 14. The baffle 41 covers the outer periphery of the cooling fan 40 from the right. The motor housing 14 has, in its left end face, multiple vents 42 surrounding the bearing 15A. The upper housing 4 has, in its rear surface, multiple inlet ports 43 being open in the motor housing 14. The upper housing 4 has, in its left side surface, multiple first outlet ports 44 below the motor housing 14.

A dust collection fan 45 is located on the right end of the rotational shaft 13 protruding from the motor housing 14. The motor housing 14 has a fan cover 46 on its right side surface. The fan cover 46 covers the dust collection fan 45 from the right. The fan cover 46 has a cylindrical air inlet 47 in its upper portion. The air inlet 47 extends upward. The fan cover 46 has multiple air outlets 48 in its lower portion radially outward from the dust collection fan 45. The upper housing 4 has multiple second outlet ports 49 in its right side surface below the handle 8B. The upper housing 4 accommodates a controller 50 on the right of the gear housing 24. The controller 50 extends vertically between the air outlets 48 and the second outlet ports 49. A power cable 51 is connected to, below the controller 50, a lower right portion of the upper housing 4. The controller 50 is operable with power supplied from the power cable 51. The controller 50 controls driving of the motor 6 in response to the switch 9 being turned on or off.

The upper housing 4 has a holding recess 55 on its upper surface. The holding recess 55 holds a dust box (dust collector) 60 described later. The holding recess 55 is a bottomed recess having a rectangular opening in a plan view at the top. A left cylinder 56 extends downward to the left from the bottom left surface of the holding recess 55. A right cylinder 57 extends downward from the bottom right surface of the holding recess 55. The left cylinder 56 is connected to the upper end of an internal hose 58. The right cylinder 57 receives the air inlet 47 in the fan cover 46 from below.

The upper housing 4 accommodates, in its left portion, the internal hose (a part of a dust collection channel) 58 extending behind the gear housing 24 in the vertical direction. The upper housing 4 has a cylindrical connection port 59 on its lower left surface. The internal hose 58 has its lower end connected to the connection port 59. The connection port 59 has its lower portion protruding downward from the lower surface of the upper housing 4.

The dust box 60 is a rectangular box having a shape in conformance with the inner shape of the holding recess 55 in a plan view. The holding recess 55 has engagement grooves 61 on its right and left inner side surfaces. The engagement grooves 61 extend in the front-rear direction. The dust box 60 has ridges 62 on its right and left outer side surfaces. The ridges 62 extend in the front-rear direction. The ridges 62 engage with the engagement grooves 61.

When the dust box 60 is fitted into the holding recess 55 from above, the ridges 62 engage with the engagement grooves 61. The dust box 60 is thus held in the holding recess 55. When the dust box 60 is pulled upward using a finger hold (not shown) on its upper surface, the ridges 62 are disengaged from the engagement grooves 61. This allows the dust box 60 to be detached from the holding recess 55.

A detection switch (detector) 63 is located below a right portion of the holding recess 55. The detection switch 63 includes a plunger 64 protruding upward from the bottom surface of the holding recess 55. The plunger 64 is depressed when the dust box 60 is attached to the holding recess 55. This turns on the detection switch 63. An on-signal is input into the controller 50.

The dust box 60 includes a partition 65 dividing the dust box 60 into a lower dust collection compartment 66 and an upper air passage 67. The dust collection compartment 66 has an inlet 68 in its lower left surface. With the dust box 60 attached to the holding recess 55, the inlet 68 connects with the left cylinder 56. A filter holder 69 is located below the partition 65. The filter holder 69 holds a filter 70. The filter 70 is a paper filter folded laterally or in the front-rear direction. The filter 70 is held laterally with a filter surface 71 facing downward. The partition 65 has a communication port 72 above the filter 70. The communication port 72 connects with the air passage 67. The air passage 67 extends to the right of the dust collection compartment 66, reaching the bottom surface of the dust box 60. The air passage 67 has an outlet 73 in its lower end. With the dust box 60 attached to the holding recess 55, the outlet 73 connects with the air inlet 47 in the fan cover 46.

The connection port 59 protruding from the upper housing 4 is connectable with a flexible hose (external hose) 75 by receiving the upper end of the flexible hose 75. The flexible hose 75 is held vertically along the lower housing 5 by a hose holder 76 externally mounted on a lower portion of the lower housing 5. The flexible hose 75 has its lower end connected to a dust collection attachment 77. The dust collection attachment 77 has a suction port 78 in its lower end. The suction port 78 is an open cup. The bit B is placeable through the suction port 78. The dust collection attachment 77 includes a cylindrical hose connector 79 protruding upward from the upper left surface of the dust collection attachment 77.

The dust collection attachment 77 is attachable by placing the bit B attached to the tool holder 35 through the dust collection attachment 77 from above, and connecting the hose connector 79 to the lower end of the flexible hose 75.

A dust collection channel R indicated by the dotted arrows in FIG. 1 is thus defined in the electric hammer 1. In the dust collection channel R, air sucked through the suction port 78 of the dust collection attachment 77 flows through the flexible hose 75 and the internal hose 58 to the dust box 60 through the inlet 68. In the dust box 60, the air passes through the dust collection compartment 66, the filter 70, and the air passage 67 in this order, and reaches the fan cover 46 through the outlet 73. The air then passes through the air outlets 48 into the upper housing 4 and is discharged through the second outlet ports 49.

To perform, for example, a crushing operation on concrete, with the suction port 78 at the lower end of the dust collection attachment 77 being in contact with or adjacent to a work surface, the switch lever 10 is pressed to turn on the switch 9. The controller 50 then determines whether an on-signal is received from the detection switch 63, or more specifically, whether the dust box 60 is attached to the holding recess 55.

With no on-signal received from the detection switch 63, the controller 50 does not drive the motor 6. With an on-signal received from the detection switch 63, the controller 50 drives the motor 6 and rotates the rotational shaft 13 together with the rotor 12. The rotation of the rotational shaft 13 is transmitted from the pinion 16 to the crankshaft 21 as reduced through the first gear 25, the second gear 26, and the third gear 27, causing the eccentric pin 28 to move eccentrically. This causes the connecting rod 22 to move the piston 23 vertically and the striker 37 to operate in response to the vertical movement of the piston 23 under a force from the air chamber 39 acting as an air spring. The vertically moving striker 37 then strikes the bit B through the impact bolt 38.

At the same time, the second crankshaft 30 engaging with the eccentric pin 28 rotates to cause the second eccentric pin 31 to move eccentrically. The counterweight 33 then vertically moves, through the second connecting rod 32, along the cylinder 29 in a direction opposite to the vertical motion of the piston 23. This reduces vibrations during striking.

As the rotational shaft 13 rotates, the cooling fan 40 and the dust collection fan 45 rotate.

The rotation of the cooling fan 40 causes the outside air to be sucked through the inlet ports 43 in the upper housing 4 and to pass through the motor 6, thus cooling the motor 6. After passing through the motor 6, the air enters the upper housing 4 through the vents 42 in the motor housing 14, flows downward, and is discharged outside through the first outlet ports 44.

The rotation of the dust collection fan 45 causes the fan cover 46 to have a negative internal pressure, generating a suction force through the suction port 78 of the dust collection attachment 77. The air sucked into the dust collection attachment 77 through the suction port 78 then passes through the dust collection channel R and is discharged out of the upper housing 4 through the second outlet ports 49. The dust sucked with the air passing through the dust box 60 is caught on the filter surface 71 of the filter 70, accumulating in the dust collection compartment 66. At this time, the air passes through the filter 70 upward from below the filter 70, causing the dust caught on the filter surface 71 to be easily released in the dust collection compartment 66. In particular, vibrations during striking facilitate release of the dust, thus reducing clogging of the filter surface 71.

The controller 50 is located in the dust collection channel R, through which the air flows from the air outlets 48 in the fan cover 46 to the second outlet ports 49 in the upper housing 4. This airflow cools the controller 50.

To discard the dust, the dust box 60 is detached from the holding recess 55 as shown in FIG. 2, allowing the dust inside the dust collection compartment 66 to be discarded through the inlet 68.

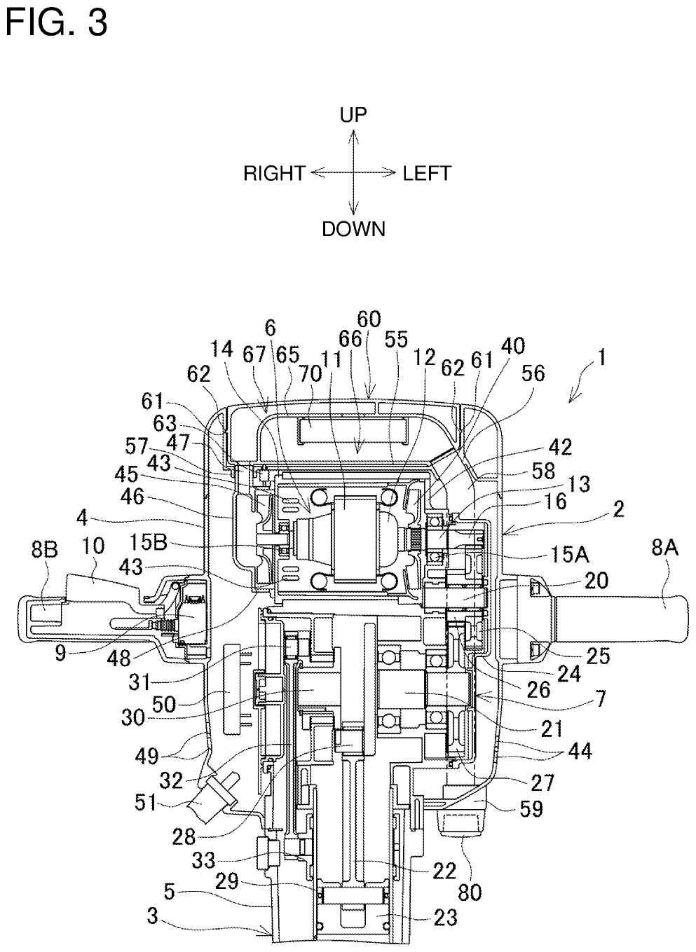

When an operation without dust collection is performed, neither the dust collection attachment 77 nor the flexible hose 75 is attached. In this case, the lower end of the connection port 59 may be closed with a cap 80 as shown in FIG. 3. This prevents foreign objects from being sucked through the connection port 59 when the dust collection fan 45 rotates.

As described above, the electric hammer 1 according to the embodiment includes the motor 6, the body 2 incorporating the motor 6, and the striker assembly 3 operable in response to the motor 6 being driven. The striker assembly 3 strikes the bit B attached along the striking axis L1.

The electric hammer 1 includes the dust collection fan 45 rotatable in response to the motor 6 being driven, the dust collection channel R having the suction port 78 being open toward the tip of the bit B to generate a suction force in the suction port 78 in response to rotation of the dust collection fan 45, and the dust box 60 located on the dust collection channel R to collect dust sucked through the suction port 78.

This structure allows dust collection using the dust box 60 without using an external dust collection device. This improves the workability.

The dust collection channel R is partially located in the body 2 as the internal hose 58.

A smaller portion of the dust collection channel R is thus exposed outside the electric hammer 1 and is less likely to interfere with operation.

The motor 6 is located along the striking axis L1.

This reduces deviation of the center of gravity from the striking axis L1, thus maintaining the overall balance.

The dust box 60 is located along the striking axis L1 opposite to the striker assembly 3 with the motor 6 in between (above the striker assembly 3 in the embodiment).

Thus, with or without the dust box 60 attached, the structure reduces deviation of the center of gravity from the striking axis L1, thus maintaining the overall balance.

The dust box 60 includes the filter 70 having the filter surface 71 facing downward. The dust box 60 allows air to pass through the filter 70 upward from below the filter 70.

This reduces accumulation of dust caught on the filter surface 71, thus prolonging clogging of the filter 70.

The electric hammer 1 includes the cooling fan 40 that cools the motor 6. The dust collection fan 45 and the cooling fan 40 are located on the opposite ends of the rotational shaft 13 of the motor 6 in the axial direction of the rotational shaft 13.

This facilitates the formation of the dust collection channel R and the airflow channel for cooling the motor 6.

The dust collection channel R includes the flexible hose 75 extending from the suction port 78 to the body 2. The body 2 includes the connection port 59 connecting with the internal hose 58 located in the body 2.

This facilitates connection between the internal hose 58 and the flexible hose 75.

The striking axis L1 extends vertically. The bit B is attached to a lower portion of the striker assembly 3. The connection port 59 is open downward.

The flexible hose 75 connecting with the connection port 59 can be routed vertically along the striker assembly 3, and is thus less likely to interfere with operation.

The dust box 60 is detachable from the body 2.

This facilitates discarding of collected dust and maintenance such as replacement or cleaning of the filter 70.

The electric hammer 1 includes the detection switch 63 that detects the dust box 60 being attached to the body 2, and the controller 50 that controls driving of the motor 6. The controller 50 does not drive the motor 6 when the detection switch 63 detects the dust box 60 being not attached.

Any operation without the dust box 60 being attached is thus restricted, allowing dust to be collected reliably into the dust box 60.

Modifications of the present disclosure will now be described.

The dust collection channel may be in a form modified as appropriate. For example, the internal hose and the flexible hose may be reversed in the lateral direction from the positions in the embodiment, or may be located frontward or rearward. The dust collection attachment may also be in a form modified as appropriate.

The internal hose may further extend into the lower housing, rather than into the upper housing. In this case, the connection port is also located in the lower housing, thus shortening the flexible hose.

The dust collection channel may be partially defined by a component other than the internal hose. For example, the dust collection channel may be partially defined by a wall in the upper housing. The wall and the internal hose may be used in combination.

The dust collection channel may be partially located outside the body, rather than being located inside the body. For example, the flexible hose may extend further upward and be routed outside the body to connect directly to the dust box.

The dust box may have a structure other than the structure allowing the dust box to be detached vertically. The dust box may be detachable from the body in the front-rear direction or in the lateral direction. The dust box may be located in a left or right portion, or in a front or rear portion of the body, rather than being located in an upper portion of the body.

The detector for the dust box can be changed based on the position of the dust box. The detector may be a contactless sensor. The detector may be eliminated. The switch may be turned on to drive the motor independently of whether the dust box is attached.

The filter in the dust box may be held vertically, rather than being held laterally. The filter may have a different thickness or shape as appropriate. The dust collection compartment and the air passage may be arranged laterally or in the front-rear direction.

The dust collector may be integral with the body, rather than being detachable. In this case, the dust collector may have a lid to be open or closed for discarding dust.

The motor may be oriented to have its rotational shaft extending in the front-rear direction or in the vertical direction, rather than in the lateral direction. The motor may not be located along the striking axis.

The cooling fan and the dust collection fan may be adjacent to each other on one end of the rotational shaft, rather than being separated on opposite ends of the rotational shaft. In this case, blades for the cooling fan may be located on one of the front and back surfaces of a disk, and blades for the dust collection fan may be located on the other of the front and back surfaces of the disk.

The motion converter is not limited to the structure in the above embodiment. The motion converter may include two or more countershafts or no countershaft. Vibration isolators such as the second crankshaft and the counterweight may be eliminated.

The power source may be a battery, rather than utility power as in the above embodiment. A detachable battery or a built-in battery may be used.

Although the electric hammer according to the above embodiment includes the striker assembly located below the body and having the striking axis extending vertically, the electric hammer may have another structure. The technique according to one or more embodiments of the present disclosure is applicable to, for example, a structure including the striker assembly located above the body to have its striking axis extending in the front-rear direction, or a structure including the striker assembly located in front of the body to have its striking axis extending in the front-rear direction.

### REFERENCE SIGNS LIST

1 electric hammer
2 body
3 striker assembly
4 upper housing
5 lower housing
6 motor
7 motion converter
9 switch
13 rotational shaft
23 piston
29 cylinder
35 tool holder
37 striker
38 impact bolt
40 cooling fan
43 inlet port
45 dust collection fan
50 controller
55 holding recess
58 internal hose
59 connection port
60 dust box
63 detection switch
66 dust collection compartment
70 filter
71 filter surface
75 flexible hose
77 dust collection attachment
78 suction port
L1 striking axis
L2 axis of rotational shaft
R dust collection channel

What is claimed is:

1. An electric hammer, comprising:
a motor,
a body incorporating the motor;
a striker assembly operable in response to the motor being driven, the striker assembly being configured to strike a bit attached along a striking axis;
a dust collection fan rotatable in response to the motor being driven;
a dust collection channel having a suction port being open toward a tip of the bit, the dust collection channel being configured to generate a suction force in the suction port in response to rotation of the dust collection fan; and
a dust collector located on the dust collection channel, the dust collector being configured to collect dust sucked through the suction port.

2. The electric hammer according to claim 1, wherein
the dust collection channel is partially located in the body.

3. The electric hammer according to claim 1, wherein
the motor is located along the striking axis.

4. The electric hammer according to claim 1, wherein
the dust collector is located along the striking axis opposite to the striker assembly with the motor in between.

5. The electric hammer according to claim 1, wherein
the dust collector includes a filter having a filter surface facing downward, and
the dust collector allows air to pass through the filter upward from below the filter.

6. The electric hammer according to claim 1, further comprising:
a cooling fan configured to cool the motor,
wherein the dust collection fan and the cooling fan are located on opposite ends of a rotational shaft of the motor in an axial direction of the rotational shaft.

7. The electric hammer according to claim 2, wherein
the dust collection channel includes an external hose extending from the suction port to the body, and
the body includes a connection port connecting with a part of the dust collection channel located in the body.

8. The electric hammer according to claim 7, wherein
the striking axis extends vertically,
the bit is attachable to a lower portion of the striker assembly, and
the connection port is open downward.

9. The electric hammer according to claim 1, wherein
the dust collector is detachable from the body.

10. The electric hammer according to claim 9, further comprising:
a detector configured to detect the dust collector being attached to the body; and
a controller configured to control driving of the motor,
wherein the controller does not drive the motor when the detector detects the dust collector being not attached.

11. The electric hammer according to claim 2, wherein
the motor is located along the striking axis.

12. The electric hammer according to claim 2, wherein
the dust collector is located along the striking axis opposite to the striker assembly with the motor in between.

13. The electric hammer according to claim 3, wherein
the dust collector is located along the striking axis opposite to the striker assembly with the motor in between.

14. The electric hammer according to claim 2, wherein
the dust collector includes a filter having a filter surface facing downward, and
the dust collector allows air to pass through the filter upward from below the filter.

15. The electric hammer according to claim 3, wherein
the dust collector includes a filter having a filter surface facing downward, and
the dust collector allows air to pass through the filter upward from below the filter.

16. The electric hammer according to claim 4, wherein
the dust collector includes a filter having a filter surface facing downward, and
the dust collector allows air to pass through the filter upward from below the filter.

17. The electric hammer according to claim 2, further comprising:
a cooling fan configured to cool the motor,
wherein the dust collection fan and the cooling fan are located on opposite ends of a rotational shaft of the motor in an axial direction of the rotational shaft.

18. The electric hammer according to claim 3, further comprising:
a cooling fan configured to cool the motor,
wherein the dust collection fan and the cooling fan are located on opposite ends of a rotational shaft of the motor in an axial direction of the rotational shaft.

19. The electric hammer according to claim 4, further comprising:
a cooling fan configured to cool the motor,
wherein the dust collection fan and the cooling fan are located on opposite ends of a rotational shaft of the motor in an axial direction of the rotational shaft.

20. The electric hammer according to claim 5, further comprising:
a cooling fan configured to cool the motor,
wherein the dust collection fan and the cooling fan are located on opposite ends of a rotational shaft of the motor in an axial direction of the rotational shaft.
